(19) United States
(12) Patent Application Publication
(10) Pub. No.: US 2011/0075401 A1
(43) Pub. Date: Mar. 31, 2011

(54) Illuminated Safety Garment

(76) Inventors: Daniel Torres, Wyoming, OH (US); Paul Torres, Wyoming, OH (US)

(21) Appl. No.: 11/852,979

(22) Filed: Sep. 10, 2007

Related U.S. Application Data
(60) Provisional application No. 60/824,914, filed on Sep. 8, 2006.

(51) Int. Cl. F21V 21/08; A41D 1/04; A41D 3/02

(52) U.S. Cl. 362/108; 2/84; 2/102; 2/93

(57) ABSTRACT

The present invention is a safety garment having electroluminescent strips to illuminate the garment, as well as quick-release points to allow an individual wearing to garment to quickly remove the garment in an emergency situation.

### CROSS-REFERENCE TO RELATED APPLICATION

The present invention claims priority to U.S. provisional Patent Application No. 60/824,914 as filed Sep. 8, 2006.

### STATEMENT REGARDING FEDERALLY SPONSORED RESEARCH

Not applicable.

### NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND ON THE INVENTION

1. Field of the Invention

The present invention relates generally to articles of clothing for improved safety, and more particularly to articles of clothing associated with actively illuminating individuals or animals, particularly in situations involving limited visibility.

2. Description of the Related Art

Physical injury and/or death are concerns known all to well to individuals in certain employment activities. For example, some individuals must work in high traffic areas as highway workers or as safety officials to direct moving vehicles away from particular lanes of traffic or work zones. Individuals working in railroad yards, industrial plants, and off-shore riggings are also at risk for physical injury or death as the individuals may be working in an area in which they are poorly visible, sometimes due to darkness or weather.

Individuals in employment circumstances are not the only individuals to which physical injury or death may arise because of limited visibility of the individual. For example, civilians who use roadways for such activities as walking, running or biking are at risk of not being properly recognized by, for example, a driver of a motorized vehicle. Like above, these risks are particularly acute in poor lighting conditions as may occur at night or during inclement weather.

As a result, there is a strong and unrelenting need for improvements in safety for such individuals. Typically, reflective safety clothing is recognized as a means for reducing the possibility of limited visibility related injuries. For example, individuals have been known to wear safety vests produced from brightly-colored and/or reflective fabrics. Some individuals wear reflective shoes and hats in order to draw attention to their presence. Improvement of such safety related articles can yield important and precious reductions in road accidents and fatalities, and as a result are highly desirable.

Although such articles of safety have saved lives, there is a significant deficiency in the clothing. In particular, much of the safety clothing of the prior art is passive in nature. That is, the brightly-colored fabrics and/or reflective aspects of the clothing require an independent illumination source from which the safety clothing may reflect light. For example, a runner may wear clothing with reflective aspects that do not provide illumination on their own. The reflective aspects require illumination from, for example, street lights and/or vehicle head-lights, in order to make the runner visible. In some poor visibility conditions, it may be too late to keep from causing physical injury or death to such a runner by the time the reflective aspects of the clothing are made visible.

Further, individuals in some circumstances risk being hit or caught by another moving body, and end up being dragged for a considerable distance. For example, a police officer working at an intersection at night could be struck by a vehicle, caught on the side mirror of the vehicle, and dragged for several blocks before the driver of the vehicle stops. Obviously, the police officer in such circumstances could be severely injured.

Thus, what is desire is a safety article of clothing that includes active illumination as well as removable panels.

### SUMMARY

The various exemplary embodiments of the present invention include a protective, illuminating garment worn by individuals during low-visibility periods or conditions, the garment comprised of a back portion, a front portion, and at least one elongated, flexible electroluminescent component on each of the back portion and the front portion. The back portion has a back top side, a back bottom side, a back left side, and a back right side. The front portion has a front top side, a front bottom side, a front left side, and a front right side. The electroluminescent component is connected to a power source. The back portion is connected to the front portion via a first connection, a second connection, a third connection, and a fourth connection. The first connection links the back top side to the front top side substantially towards the back right side and the front right side. The second connection links the back top side to the front top side substantially towards the back right side and the front right side. The third connection links the back right side to the front right side of the front portion. The fourth connection links the back left side to the front right side of the front portion. The at least one flexible electroluminescent strip on the back portion is connected to the at least one electroluminescent component on the front portion via a detachable lead completing an electric current between each of the at least one electroluminescent components, and the detachable lead is substantially located at one or more of the first connection, second connection, third connection, and fourth connection. When a sufficient force is applied, each of the connector, first connection, second connection, third connection, and fourth connection will disengage to allow an individual wearing the garment to remove the garment without injury.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is an illustration of a garment according to the various exemplary embodiments of the present invention.

FIG. 2 is an illustration of a connection and detachable lead according to the various exemplary embodiments of the present invention.

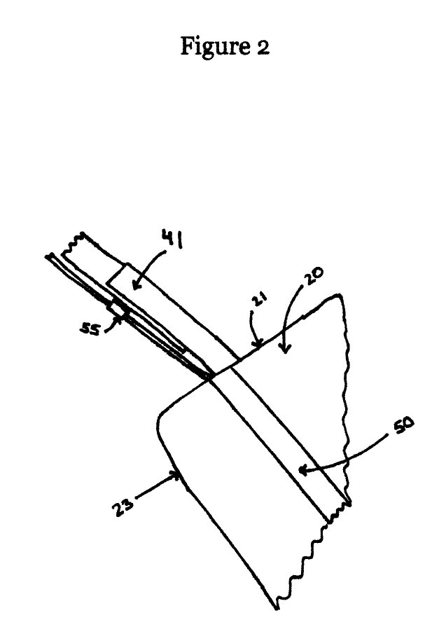

FIG. 3 is an illustration of garment having a removable flap according the various exemplary embodiments of the present invention.

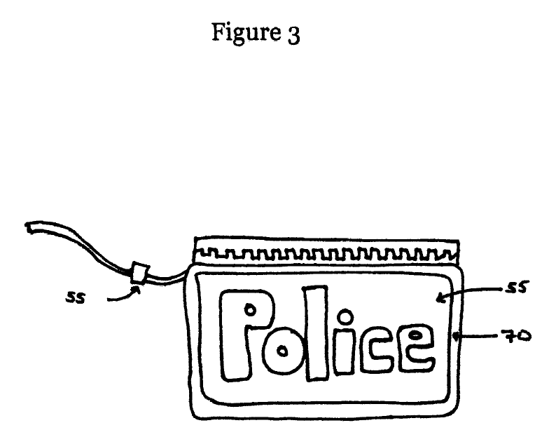

### DETAILED DESCRIPTION

In the following detailed description, reference is made to the accompanying drawings which form a part hereof, and in which is shown, by way of illustration, exemplary embodiments in which the invention may be practiced. In the drawings, like numerals describe substantially similar components throughout the several views. These embodiments are described in sufficient detail to enable one of ordinary skill in the art to practice the invention. Other various exemplary embodiments may be utilized, and structural, logical, and electrical changes may be made without departing from the scope of the present invention.

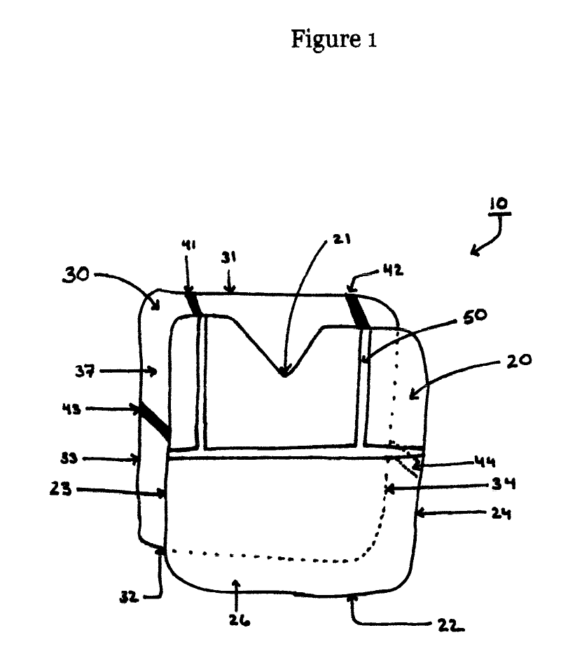

An exemplary embodiment of the present invention is illustrated in FIG. 1, wherein an illuminated safety garment 10 is shown. The safety garment represented is in the form of a safety vest.

Although a safety vest is shown in the drawings, it should be understood that any form of safety garment that satisfies the aspects of the present invention may be utilized. Examples include jackets, hooded jackets, overcoats, raincoats, ponchos, windbreakers, and the like. Further, although the drawings present a garment having only a front portion and a back portion, it should be understood that the present invention may be adapted to any conventional garment.

The safety garment 10 is comprised of a front portion 20 and a back portion 30. The front portion includes a front top side 21, a front bottom side 22, a front right side 23, and a front left side 24. The front portion also includes a front outside 26 and a front inside (not shown). The back portion includes a back top side 31, a back bottom side 32, a back right side 33, and a back left side 34. The back portion also includes a back outside (not shown) and a back inside 37.

The front portion and the back portion are connected to one another such that the front inside faces the back inside.

The front portion and the back portion are connected to one another by at least four or more connections. The first connection 41 is preferably located between the front top side 21 and the back front side 31 towards the front right side 23 and the back right side 33. The second connection 42 is preferably located between the front top side 21 and the back front side 31 towards the front left side 24 and the back left side 34. The third connection 43 is preferably located between the front right side 23 and the back right side 33. The fourth connection 44 is preferably located between the front left side 24 back left side 34.

The at least four connections are situated such that the garment may be worn by an individual wherein the individual's head (not shown) is between the first connection 41 and the second connection 42, the individual's right arm may extend between the first connection 41 and the third connection 43, and the individual's left arm may extend between the second connection 42 and the fourth connection 44.

Each of the four or more connections may vary in size depending on the garment of interest.

The four or more connections are preferably a connecting means that allows for quick disengagement of the connection. Examples of preferred connecting means include snap fasteners, loop and hook fasteners, i.e., VELCRO®, magnets, or a combination thereof. In a most preferred embodiment, the four or more connections are loop and hook fasteners. It is preferred that the four or more connections quickly disengage so as to substantially obviate further injury to an individual wearing a garment according to the various exemplary embodiments in the circumstances wherein a moving body catches hold of the garment.

For example, a coat worn by an individual working in a railroad yard may be accidentally caught and pulled under a moving train. If the individual wears a garment according to the exemplary embodiments herein, he may be able to escape significant injury or death by releasing himself from the garment caught by the moving train.

The safety garment according to the various exemplary embodiments of the present invention further comprises one or more electroluminescent lamp (EL) strips 50 on the front outside and the back outside.

The EL strips according to the various exemplary embodiments herein are in the shape of rectangles; however, the EL strips may be of any shape or configuration, including, for example, square, circular, waves, etc. Further, the EL strips may be partially covered such that it one or more symbols or letters is illuminated. For example, an EL strip may be covered such that the words “Police” are illuminated.

The EL strips may be attached to the safety garment in any known method, including, for example, sewing, adhesive, flexible plastic sleeves, etc.

The EL strips are connected to a power source (not shown), preferably held in a pocket in the front inside or back inside of the garment. The power source preferably has a power switch (not shown) for turning the power source on or off. The power source comprises a battery, and a detachable electrical lead 55.

Each of the one or more EL strips 50 are flexible and thin, preferably having the thickness of about two millimeters or less.

The El strips may be produced in any color as desired or needed for the circumstances or job. For example, jobs or roles that demand color-coded outfits such as, for example, flight crews on aircraft carriers, may each be illuminated in colored light associated with the related job or role.

The EL strips are also water-resistant and water-proof. The EL strips are also highly durable in that they may be damaged by being pierced or cut, but the EL strips will continue to illuminate so long as they are provided an electrical current.

In a preferred embodiment, the EL strips are located on both the front outside and the back outside of the garment, and the EL strips are all connected to a single power source. In such embodiment, the EL strips on the front outside are coupled to the EL strips on the back outside via one or more detachable leads. Having EL strips coupled to one another via detachable leads 55 in such fashion allows for the coupled EL strips to “break away.”

It is preferred that the detachable leads that couple the EL strips be adjacent to the one or more connections. For example, a detachable lead may connect an EL strip on the front outside of a garment with a second EL strip on the back outside of the garment at the substantially same location as the first connection 41.

The detachable leads may include a quick-release holding means (not shown) to ensure proper electrical connection between EL strips, but also allowing for disengagement of the connection when needed. Examples of such quick-release holding means include hook and loop fastener, snaps, magnets, and combinations thereof.

Detachable leads allows for a proactive illumination of a garment worn by an individual, while also allowing for easier release of an individual from the illuminated garment should the circumstances require it as in the above example of the railroad worker caught by a moving train.

If non-detachable leads are used, wires must lead from the front to the back of the garment, which may cause significant problems to the wearer should he need to quickly exit the garment in an emergency. Further, if the EL grips on the front and the back are not connected, each would likely require a separate power source, which would lead to additional weight and cost to the garment.

In an exemplary embodiment, the garment may also comprise a removable flap 70. The removable flap may be connected to the garment as desired by way of a zipper, hook and fastener, snap fastener, straps, magnets, buttons, or a combination thereof. The removable flap includes a transparent pocket for retaining an EL strip 50. The EL strip in the removable flap preferably is partially covered to as to form an illuminated symbol or arrangement of letters, for example, “Sheriff.” The removable flap may be removed from the garment as needed, and the EL strip in the removable flap may be removed and replaced with other EL strips as needed. The EL strip in the removable flap is connected to a detachable lead 55 further connected to the power source.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention.

What is claimed is:

1. A protective, illuminating garment worn by individuals during low-visibility periods or conditions, the garment comprising:
a back portion having a back top side, a back bottom side, a back left side, and a back right side;
a front portion having a front top side, a front bottom side, a front left side, and a front right side; and
at least one elongated, flexible electroluminescent component on each of the back portion and the front portion, such that the electroluminescent component is connected to a power source;
wherein the back portion is connected to the front portion via a first connection, a second connection, a third connection, and a fourth connection; the first connection linking the back top side to the front top side substantially towards the back right side and the front right side; the second connection linking the back top side to the front top side substantially towards the back right side and the front right side; the third connection linking the back right side to the front right side of the front portion; the fourth connection linking the back left side to the front right side of the front portion; further wherein the at least one flexible electroluminescent strip on the back portion is connected to the at least one electroluminescent component on the front portion via a detachable lead completing an electric current between each of the at least one electroluminescent components, and the detachable lead is substantially located at one or more of the first connection, second connection, third connection, and fourth connection; and when a sufficient force is applied, each of the connector, first connection, second connection, third connection, and fourth connection will disengage to allow an individual wearing the garment to remove the garment without injury

2. The garment according to claim 1, further comprising a hood connected to the top side of the back portion.

3. The garment according to claim 1, wherein the front portion is comprised of a front right section and a front left section, such that the front right section and front left section are substantially similar in size and attach to one another substantially in a center region of the front portion.

4. The garment according to claim 3, wherein the front right section and front left section are attached via a zipper.

5. The garment according to claim 3, wherein the front right section and front left section are attached via one or more snap fasteners.

6. The garment according to claim 1, wherein the first connection, the second connection, third connection, and fourth connection are comprised of hook and loop fasteners.

7. The garment according to claim 1, wherein the first connection, the second connection, third connection, and fourth connection are comprised of snap fasteners.

8. The garment according to claim 1, wherein the garment is a vest.

9. The garment according to claim 1, wherein the garment is a jacket or coat.

10. The garment according to claim 1, further comprising a removable flap having a transparent covering for retaining an electroluminescent strip, wherein the electroluminescent strip is connected to the power source via a detachable lead.

11. The garment according to claim 10, wherein the removable flap is connected to the garment via a zipper, series of two or more snap fasteners, hook and loop fasteners, magnets, or a combination thereof.

12. The garment according to claim 10, wherein the electroluminescent component displays one or more predetermined symbols.

13. The garment according to claim 1, wherein the one elongated, flexible electroluminescent component on the back portion is in any geometric shape
